(19) United States
(12) Patent Application Publication
(10) Pub. No.: US 2025/0167445 A1
(43) Pub. Date: May 22, 2025

(54) ANTENNA SYSTEMS

(71) Applicant: Parsec Technologies, Inc., Plano, TX (US)

(72) Inventors: Michael A. Neenan, Plano, TX (US); Richard Loy Smith, JR., Dallas, TX (US); Rauhon Ahmed Shaik, Wylie, TX (US); George Alexander Bednekoff, Plano, TX (US)

(21) Appl. No.: 18/893,548

(22) Filed: Sep. 23, 2024

Related U.S. Application Data
(60) Provisional application No. 63/585,190, filed on Sep. 25, 2023.

(51) Int. Cl. H01Q 5/10; G01S 19/36; H01Q 1/22; H01Q 1/42; H01Q 5/20

(52) U.S. Cl. CPC H01Q 5/10; G01S 19/36; H01Q 1/2291; H01Q 1/42; H01Q 5/20

(57) ABSTRACT

An antenna assembly is disclosed. The antenna assembly can include a housing, a first multi-band antenna element, and a second multi-band antenna element. The first multi-band antenna element is configured for cellular applications and positioned within the housing. The first multi-band antenna element includes a first low-band radiating element and a first mid-band radiating element. The second multi-band antenna element is configured for cellular applications and positioned within the housing. The second multi-band antenna element includes a second low-band radiating element and a second mid-band radiating element.

### INCORPORATION BY REFERENCE TO ANY PRIORITY APPLICATIONS

The present application claims priority benefit to U.S. Provisional Application No. 63/585,190, filed Sep. 25, 2023, entitled “ANTENNA SYSTEMS,” which is hereby incorporated by reference herein in its entirety. Any and all applications for which a foreign or domestic priority claim is identified in the Application Data Sheet as filed with the present application are hereby incorporated by reference under 37 CFR 1.57 and made a part of this specification.

### BACKGROUND

### Field

The present disclosure relates to the field of wireless broadband communication, and more particularly to antenna systems and antennas that cover multiple frequency bands used in the telecommunication wireless spectrum.

### Description of the Related Art

Over the last few decades, 3GPP as a collaborative organization has developed protocols for mobile telecommunications. The latest operational standard is known as 5G. Wireless communication relies on a variety of radio components including radio antennas that are used for transmitting and receiving information via electromagnetic waves. To communicate to specific devices without interference from other devices, radio transceivers and receivers communicate within a dedicated frequency bandwidth and have associated antennas that are configured to electromagnetically resonate at frequencies within the dedicated bandwidth. As more wireless devices are used on a frequency bandwidth, a communication bottleneck occurs as wireless devices compete for frequency channels within a dedicated bandwidth. 3GPP frequency bands range from 450 MHz to 8 GHz and beyond, however, antennas configured to resonate within this spectrum only resonate below 8 GHz for mobile 3GPP telecommunication standards. To capture a greater portion of the 3GPP or other telecommunication spectrum, either an antenna array of various antenna configurations is used, or a single geometrically complex antenna can be used. An antenna array, in most instances, takes up too much space and is therefore impractical for small devices, but employing a single antenna will have a useable bandwidth that is limited by its geometrical configuration. In one example, a known antenna configuration permits a 700 MHz-2.7 GHz frequency band; however, a single antenna configuration that permits a wider frequency band is desired. Additionally, it can be difficult and expensive to manufacture, assemble, and procure materials for components of antenna array systems. This may result in a system with poor functionality and/or coverage.

### SUMMARY

This disclosure relates to antennas that cover multiple frequency bands that are prolific in today's telecommunication wireless spectrum. The advances of telecommunications wireless devices have expanded the number of frequency bands that a radio can support for prolific coverage. For example, there are over 30 5G Bands that a radio may be asked to support if the radio is to provide ubiquitous coverage for a mobile device. While some of the LTE Bands overlap one another, there are numerous gaps between the bands as well. A multi-band approach to the antenna's frequency response provides a unique and novel radiating structure to support the numerous 5G bands.

According to some advantageous implementations, an antenna assembly is disclosed. The antenna assembly can include: a front cover; a back cover, the back cover configured to be coupled to the front cover; a first PCB base and a second PCB base positioned between the front cover and the back cover, wherein each of the first PCB base and the second PCB base include: a multi-band antenna element, the multi-band antenna element including: one or more first low-band radiating elements; and one or more mid-band radiating elements, wherein the front cover and the back cover include an H-shape.

According to some advantageous implementations, an antenna assembly is disclosed. The antenna assembly includes a housing, a first antenna member, and a second antenna member. The housing includes a first side portion, a second side portion, and a middle portion extending between the first side portion and the second side portion. The middle portion is substantially orthogonal to the first side portion and the second side portion. A continuous internal volume is defined within the first side portion, the middle portion, and the second side portion. The first antenna member includes a first multi-band antenna element. The first antenna member is positioned within the continuous internal volume in the first side portion. The second antenna member includes a second multi-band antenna element. The second antenna member is positioned within the continuous internal volume in the second side portion.

According to some advantageous implementations, an antenna assembly is disclosed. The antenna assembly includes a housing, a first multi-band antenna element, and a second multi-band antenna element. The first multi-band antenna element is configured for cellular applications and positioned within the housing. The first multi-band antenna element includes a first low-band radiating element and a first mid-band radiating element. The second multi-band antenna element is configured for cellular applications and positioned within the housing. The second multi-band antenna element includes a second low-band radiating element and a second mid-band radiating element.

According to some advantageous implementations, an antenna member is disclosed. The antenna member is configured for Wi-Fi applications. The antenna member includes a support structure and a multi-band antenna element. The support structure includes a first side and a second side, the second side including a ground plane. The multi-band antenna element includes a first pair of dual-band arms and a second pair of dual-band. The dual-band arms of the first pair of dual-band arms and the second pair of dual-band arms include dipole arms. Each dual-band arm includes a first mid-band radiating element and a first high-band radiating element positioned on the first side of the support structure, and a second mid-band radiating element and a second high-band radiating element positioned on the second side of the support structure.

Some advantageous features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one implementation of the present disclosure in detail, it is to be understood that the implementations are not limited in its application to the details of construction and the arrangements of the components set forth in the following description or illustrated in the drawings. The implementations are capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. Accordingly, the claims should be regarded as including such equivalent constructions in so far as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 illustrates a front perspective view of an antenna assembly, in accordance with some aspects of this disclosure.

FIG. 2A illustrates a front cover of the antenna assembly of FIG. 1, in accordance with some aspects of this disclosure.

FIG. 2B illustrates a back cover of the antenna assembly of FIG. 1, in accordance with some aspects of this disclosure.

FIG. 3 illustrates a front perspective view of the antenna assembly of FIG. 1 with the front cover removed, in accordance with some aspects of this disclosure.

FIG. 4 illustrates a top view one or more multi-band antenna elements of the antenna assembly of FIG. 1, in accordance with some aspects of this disclosure.

FIG. 5 illustrates a front perspective view of another antenna assembly with the front cover removed, in accordance with some aspects of this disclosure.

FIG. 6A illustrates a top view one or more multi-band antenna elements of the antenna assembly of FIG. 5, in accordance with some aspects of this disclosure.

FIG. 6B illustrates a bottom view one or more multi-band antenna elements of the antenna assembly of FIG. 5, in accordance with some aspects of this disclosure.

While the implementations and method of the present application is susceptible to various modifications and alternative forms, specific implementations thereof have been shown by way of example in the drawings and are herein described in detail. It should be understood, however, that the description herein of specific implementations is not intended to limit the application to the particular implementation disclosed, but on the contrary, the intention is to cover all modifications, equivalents, and alternatives falling within the spirit and scope of the process of the present application as defined by the appended claims.

### DETAILED DESCRIPTION

Illustrative implementations of the present disclosure are described below. In the interest of clarity, not all features of an actual implementation are described in this specification. It will of course be appreciated that in the development of any such actual implementation, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the implementations described herein may be oriented in any desired direction.

The system and method will be understood, both as to its structure and operation, from the accompanying drawings, taken in conjunction with the accompanying description. Several implementations of the system may be presented herein. It should be understood that various components, parts, and features of the different implementations may be combined together and/or interchanged with one another, all of which are within the scope of the present application, even though not all variations and particular implementations are shown in the drawings. It should also be understood that the mixing and matching of features, elements, and/or functions between various implementations is expressly contemplated herein so that one of ordinary skill in the art would appreciate from this disclosure that the features, elements, and/or functions of one implementation may be incorporated into another implementation as appropriate, unless otherwise described. As used herein, “system” and “assembly” are used interchangeably. It should be noted that the articles “a”, “an”, and “the”, as used in this specification, include plural referents unless the content clearly dictates otherwise. Dimensions provided herein provide for an exemplary implementation, however, alternate implementations having scaled and proportional dimensions of the presented exemplary implementation are also considered. Additional features and functions are illustrated and discussed below.

### Antenna Assembly

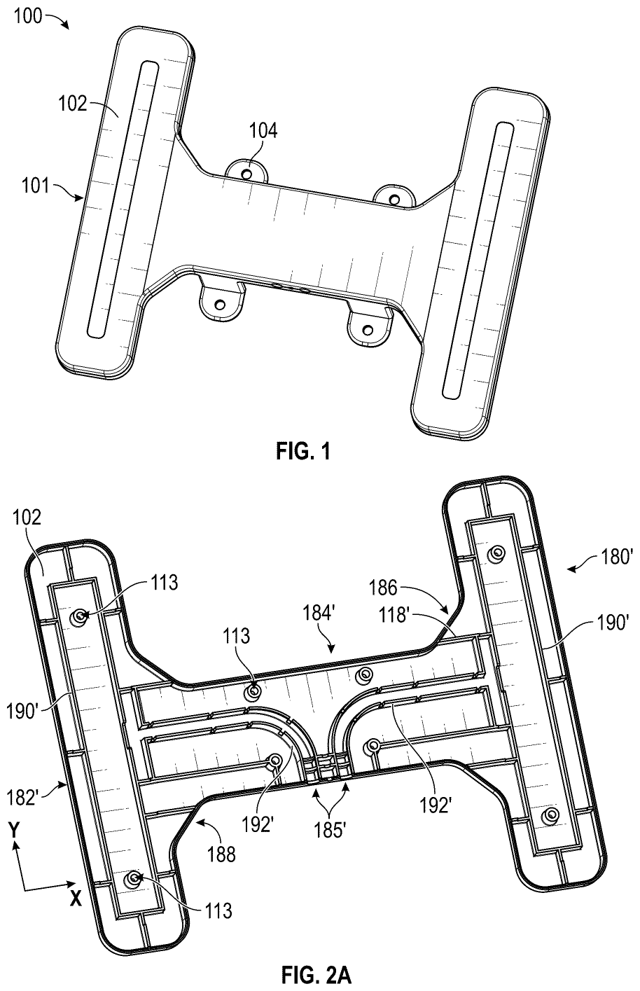

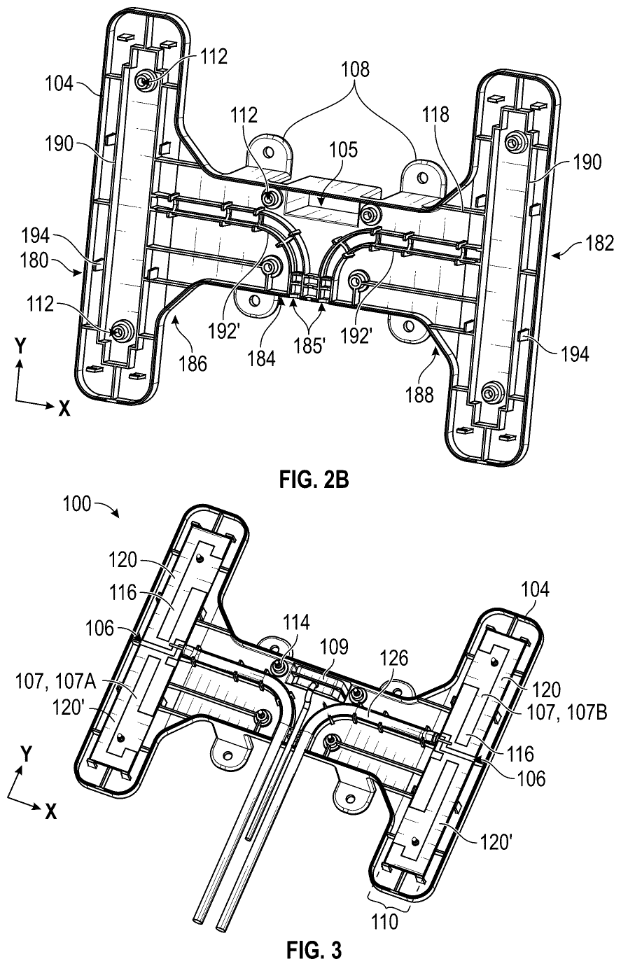

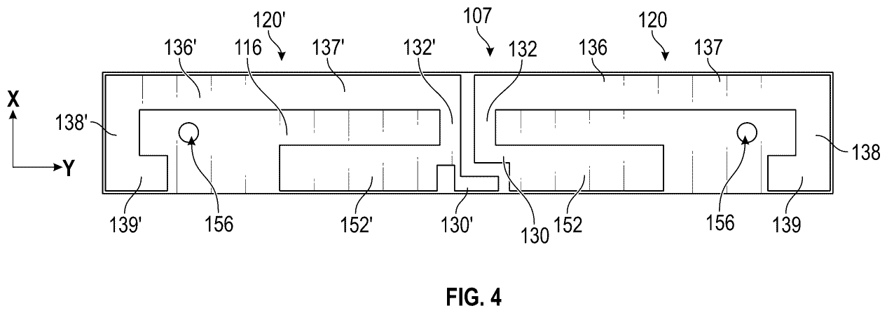

Referring now to the drawings wherein like reference characters identify corresponding or similar elements in form and function throughout the several views. FIG. 1 illustrates a front perspective view of an antenna assembly. FIGS. 2A and 2B illustrate a front cover and a back cover of the antenna assembly of FIG. 1 respectively. FIG. 3A illustrates a front perspective view of the antenna assembly of FIG. 1 with a front cover removed. FIG. 4 illustrates a multi-band antenna element of the antenna assembly of FIG. 1.

According to some embodiments, features, and aspects of this disclosure, an antenna assembly is disclosed. The antenna assembly can include a front cover, a back cover, and one or more antenna elements. Each antenna element can be formed on or can comprise a printed circuit board (“PCB”). Accordingly, the antenna elements may be referred to herein as “PCB antenna elements”. The back cover can be configured to be coupled to the front cover, with the PCB antenna element(s) positioned between the front cover and the back cover. The antenna assembly can include a first multi-band antenna element formed on each PCB base and a second multi-band antenna element formed on each PCB base. In some implementations, the multi-band antenna elements can include radiating elements configured to radiate at specific frequency bands. For example, the radiating elements can be configured for low-band operation (approximately 600 MHz to 900 MHz), mid-band operation (approximately 1.7 GHz to 2.7 GHz), CBRS-band operation (approximately 3.4 GHz to 4.2 GHz), or Wi-Fi-band operation (approximately 4.8 GHz to 7.25 GHz), depending on the desired performance of the antenna assembly. In the illustrated example, the first multi-band antenna element can include one or more first low-band radiating elements, and one or more first mid-band radiating elements. The second multi-band antenna element can include one or more second low-band radiating elements, and one or more second mid-band radiating elements. The low-band radiating elements can have a frequency range of approximately 600 MHz to 900 MHz. This range can provide excellent propagation for long-range coverage and/or indoor penetration. For example, signals in the low-band range can travel long distances and/or penetrate obstacles (e.g., walls) effectively. In some cases, the low-band radiating elements may be used for cellular communication and/or for 4G LTE or 5G applications. The mid-band radiating elements can have a frequency range of approximately 1.7 GHz to 2.7 GHz. This range can provide balanced propagation between range and capacity. For example, the mid-band range can provide improved data rates compared to the low-band, but at reduced range and penetration. In some cases, the mid-band radiating elements can be used for 4G LTE, 5G, and/or Wi-Fi (2.4 GHz) applications. In other implementations, the first multi-band antenna element and/or the second multi-band antenna element can include one or more CBRS-band radiating elements and/or Wi-Fi band radiating elements.

The following detailed description of certain implementations presents various descriptions of specific implementations. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain implementations can include more elements than illustrated in a drawing and/or a subset of the elements illustrated in a drawing. Further, some implementations can incorporate any suitable combination of features from two or more drawings.

Objects that are coupled together can be permanently connected together or releasably connected together. Objects that are permanently connected together can be formed out of one sheet of material or multiple sheets of material. The type of connection can provide different means for the realization of particular advantages and/or convenience consistent with the suitable function and performance of the device.

With reference to FIG. 1, a perspective front side view of an antenna assembly 100 is illustrated in accordance with an implementation of the present disclosure. The antenna assembly 100 can include a first/front cover 102, a second/back cover 104, and a multi-element multi-band antenna 106 (see e.g., FIG. 3). The antenna assembly 100 can be configured to provide wireless internet connectivity for a plurality of uses (e.g., data, voice communication, video, and/or the like). The antenna assembly 100 can be used in a wide range of applications. The antenna assembly 100 can be an omni-directional antenna for increasing data speeds of cellular coverage inside buildings. For example, the antenna assembly 100 can be used for data and voice communication. The antenna assembly 100 can be used for 4G LTE and/or 5G applications. The antenna assembly 100 can be a 2×2 MIMO cellular, omni-directional antenna. In some implementations, the multi-element multi-band antenna 106 can have an operating frequency range of 500 MHz to 8.0 GHz. In some cases, the multi-element multi-band antenna 106 can have optimal performance when operating at a frequency of 600 MHz to 2.7 GHz. In some cases, the multi-element multi-band antenna 106 can have optimal performance when operating at a frequency range of 600 MHz to 4.0 GHz. In some cases, the multi-element multi-band antenna 106 can have optimal performance when operating at a frequency range of 600 MHz to 6.0 GHz. In other implementations, other operating frequency ranges are possible. In some cases, the antenna assembly 100 can be used as plain old telephone service (POTS) replacement and/or at unmanned retail stores, kiosks or the like. The antenna assembly 100 can have a smaller volume and profile when compared to other antenna systems. The antenna assembly 100 can have an “H” shape defined by the covers 102, 104. The H-shaped covers 102, 104 can help to reduce or minimize wind loads applied to the antenna assembly 100 and/or improve the appearance (e.g., visual impact) of the antenna assembly 100.

With reference to FIGS. 2A and 2B, the antenna assembly 100 can have a housing 101. The housing 101 can include the front cover 102 and the back cover 104. The covers 102, 104 can protect and/or provide mechanical support for the internal components of the antenna assembly 100 (e.g., the multi-element multi-band antenna 106). For example, as discussed herein, the multi-element multi-band antenna 106 can be supported by the back cover 104 and enveloped by the front cover 102. In some implementations, the front cover 102 and/or the back cover 104 can be transparent to radiation from the multi-element multi-band antenna 106 and can serve as an environmental shield for the internal components of antenna assembly 100. One or both of the front cover 102 and back cover 104 can be made of non-conductive materials. For example, the covers 102, 104 may not be made of metal. In some examples, the covers 102, 104 can be made of plastic, fiberglass, carbon fiber, and/or the like materials that allow radio frequency (“RF”) signals to pass through. The front cover 102 can be configured to be removably coupled to the back cover 104. The housing 101 can be generally “H” shaped. The front cover 102 can be generally “H” shaped. In some cases, the front cover 102 can have rounded corners and/or sides. Similarly, the back cover 104 can be generally “H” shaped. In some cases, the back cover 104 can have rounded corners and/or sides. A top edge of the back cover 104 can be configured to interface with a bottom edge of the front cover 102. Other shapes are possible for the covers 102, 104.

The back cover 104 can include one or more attachment portions 108 (see e.g., FIG. 2B). The attachment portions 108 can be used to mount the antenna assembly 100 to various locations. The type of the attachment portion 108 included in the antenna assembly 100 can vary based on the intended mounting manner and location. While one example attachment portion 108 is shown, the antenna assembly 100 can include any number of attachment portions 108, depending on the use. In the illustrated example, the back cover 104 includes an attachment portion 108 that is shaped as a mounting plate. The attachment portion 108 can extend from the back side of the back cover 104 in a direction away from the front cover 102. The attachment portion 108 can be configured to allow the antenna assembly 100 to be mounted to various structures, such as walls, vehicles, customer premise equipment (e.g., vehicles, buildings, indoor or outdoor equipment enclosures, and/or the like), or the like. For example, the attachment portion 108 could be used to fix the antenna assembly 100 to a wall. In another example, the attachment portion 108 could be used to fix the antenna assembly 100 to a pole (e.g., with a bracket). In other implementations, a different attachment portion 108 can be used in the antenna assembly 100. For example, the attachment portion 108 could be one or more worm gear clamps for pole mounting applications.

The back cover 104 forms the base of the antenna assembly 100. The back cover 104 provides mechanical support for the internal components of the antenna assembly 100. As shown in FIG. 1, the front cover 102 can be positioned on the back cover 104 to secure the internal components of the antenna assembly 100. As shown in FIG. 2B, the front cover 102 can include a plurality of front fastener holes 113, which can extend into the front cover 102. In some implementations, the front fastener holes can be tapered. In some implementations, the front fastener holes can be threaded. These plurality of front fastener holes 113 can be aligned with back cover holes 112 of the back cover 104 in the assembled configuration, and fasteners 114 (e.g. see FIG. 3 can be positioned within the front fastener holes and the back cover holes 112 to secure the front cover 102 and the internal components of the antenna assembly 100 to the back cover 104.

FIG. 3 illustrates a front perspective view of the antenna assembly 100 with the front cover 102 removed to further illustrate the internal components of the antenna assembly 100. The antenna assembly 100 can include two or more antenna members 107. The antenna members 107 can be housed within the antenna assembly 100 (e.g., between the front cover 102 and the back cover 104). The antenna members 107 can each include one or more multi-band antenna elements 120, 120′ comprising radiating elements formed on a support structure (e.g., PCB bases 116). For example, the conductive tracing of the radiating elements can be formed on the PCB bases 116 to define the multi-band antenna elements 120, 120′ of the antenna members 107.

In the illustrated example, the antenna assembly 100 includes a first antenna member 107A and a second antenna member 107B (collectively antenna members 107). In some cases, the PCB bases 116 can be fiberglass reinforced with epoxy (e.g., FR4). The PCB bases 116 can provide structure for the radiating elements/portions of the multi-band antenna elements 120, 120′ of the antenna members 107. For example, the radiating elements/portions can be conductive material (e.g., copper) that can be etched into the structure of the PCB bases 116.

The internal side of the back cover 104 can include internal ribbing structure 118. The antenna members 107 can be positioned on and supported by the internal ribbing structure 118. The internal ribbing structure 118 can provide separation between the antenna members 107 and the back cover 104. Additionally, the structure of the front cover 102 and back cover 104 can provide electrical isolation between the fasteners (e.g., fasteners 114) and the electrically conductive surfaces of the antenna members 107 (e.g., the multi-band antenna elements 120, 120′).

FIG. 4 illustrates a top side view of an antenna member 107 of the multi-element multi-band antenna 106, such as the first antenna member 107A. The antenna member 107 can include one or more multi-band antenna elements. In the illustrated example, the antenna member 107 includes a multi-band antenna element 120. In the illustrated example, the entire multi-band antenna element 120 is formed on one side of the PCB base 116. In other implementations, some portions of the multi-band antenna element 120 could be formed on a first/front side of the PCB base 116 and some portions of the multi-band antenna element 120 could be formed on a second/back side of the PCB base 116.

The multi-band antenna element 120 can include a first feed point 130 and a first balun 132. The first feed point 130 can be coupled to the first balun 132. For example, the first feed point 130 can be the point where the electrical energy from a coaxial cable 126 of the antenna assembly 100 is transferred to the first balun 132. The center conductor of the coaxial cable 126 can attach to the first feed point 130 and/or the first balun 132. The first balun 132 extends to the multi-band antenna element 120. The impedance of the first feed point 130 can vary, depending on the application of the antenna assembly 100. As explained herein, the first and second multi-band antenna elements 120, 120′ of the antenna member 107 can be configured to assist in the impedance matching and pattern construction of the multi-element multi-band antenna 106.

The tuning of the radiating elements of the multi-band antenna element 120 can be achieved by balancing a number of factors. These factors can include one or more of: the width of the baluns 132, 132′, the dielectric constant (“DK”) of the PCB base 116, the geometry of the radiating elements of the first multi-band antenna element 120 and their spacing relative to each other, the feed impedance, and/or the like.

With continued reference to FIG. 4, the first multi-band antenna element 120 can include a number of radiating elements. The radiating elements may be configured as dipole arms and may be referred to herein as “arms” or “dipole arms” accordingly. For example, the first multi-band antenna element 120 can include one or more mid-band arms, and/or one or more low-band arms. In some cases, the first multi-band antenna element 120 can include one or more arms configured for a different frequency band, such as the CBRS-band or Wi-Fi-band. In the illustrated embodiment, the multi-band antenna element 120 includes a dipole arm for mid-band and low-band radiation.

As shown, in the illustrated example, the first multi-band antenna element 120 can include a low-band radiating element 136 (also referred to herein as the first low-band arm 136). The low-band arm 136 can be configured for low band radiation (e.g., radiation less than approximately 1 GHz). The low-band arm 136 can form a portion of a dipole of the multi-band antenna element 120 (e.g., the driven element). The low-band radiating element 136 can be coupled to or extend from the first balun 132. The low-band radiating element 136 can be a “C” shaped. The low-band radiating element 136 can include a first portion 137, a second portion 138, and a third portion 139. The first portion 137 can extend in the positive Y-direction from the first balun 132 along a top-side of the PCB 116. The second portion 138 is perpendicular to the first portion 137 such that the second portion 138 extends from the first portion 137 in a negative X-direction. The third portion 139 is perpendicular to the second portion 138 and/or parallel with the first portion 137, such that the third portion 139 extends from the second portion 138 in a negative Y-direction. In some implementations, the first portion 137 is longer than the second portion 138 and the second portion 138 is longer than the third portion 139. In other implementations, the low-band radiating element 136 can have a different shape. This arrangement can reduce the size of the PCB 116 required and/or prevent or inhibit interference between the low-band radiating element 136 and other portions of the element 120.

The first multi-band antenna element 120 can include one or more mid-band radiating elements/arms/dipole arms. In the illustrated example, the first multi-band antenna element 120 can include a mid-band radiating element 152 (also referred to herein as the mid-band arm 152). The mid-band arm 152 can be configured for mid band radiation (e.g., radiation approximately between 1700 MHz to 2700 MHz). The mid-band arm 152 can form a portion of the dipole of the first multi-band antenna element 120 (e.g., the driven element). The mid-band radiating element 152 can extend in the positive Y-direction. The mid-band radiating element 152 can be coupled to or extend from the first balun 132. The mid-band radiating element 152 can extend in the positive Y-direction from the first balun 132. The mid-band radiating elements 152 can be rectangularly shaped. In other implementations, the mid-band radiating elements 152 can be shaped differently. In some implementation, the mid-band radiating element 152 can be positioned near one or more edges of the PCB base 116. For example, the mid-band radiating element 152 can extend along a bottom-side edge of the PCB base 116 (e.g., in the positive Y-direction). This arrangement can reduce the size of the PCB base 116 required.

In some implementations, at least a portion of the first multi-band antenna element 120 can include a high-band radiating element.

In some cases, one or more holes 156 can extend through the PCB base 116. The one or more holes 156 can allow fasteners or other mechanical components of the antenna assembly 100 to extend through the PCB base 116 (e.g., for securing the front cover 102 to the back cover 104). The one or more holes 156 are not required and some implementations of the antenna assembly 100 will not include the one or more holes 156.

As noted herein, the multi-element multi-band antenna 106 can include a first multi-band antenna element 120 and a second multi-band antenna element 120′ formed on the same PCB base 116. Some features of the second multi-band antenna element 120′ are similar or identical to features of the first multi-band antenna element 120 in at least FIG. 4. Thus, reference numerals used to designate the various features or components of the first multi-band antenna element 120 are identical to those used for identifying the corresponding features or components of the second multi-band antenna element 120′ in at least FIG. 4, except that the numerical identifiers for the second multi-band antenna element 120′ include a “prime”. Therefore, the structure and description for the various features of the first multi-band antenna element 120 and the operation thereof as described in at least FIG. 4 are understood to apply to the corresponding features of the second multi-band antenna element 120′, except as described differently below.

The second multi-band antenna element 120′ differs from the first multi-band antenna element 120 in the position and orientation on the PCB base 116. In some implementations, the second multi-band antenna element 120′ can be a mirror image of the first multi-band antenna element 120. For example, the first portion 137′ of the low-band radiating element 136′ of the second multi-band antenna element 120′ can extend in the negative Y-direction and the third portion 139′ of the low-band radiating element 136′ of the second multi-band antenna element 120′ can extend in the positive Y-direction. Similarly, the mid-band radiating element 152′ of the second multi-band antenna element 120′ can extend in the negative Y-direction. The second feed point 130′ can be positioned between the first feed point 130 of the first multi-band antenna element 120 and an edge of the PCB base 116. The outer conductor of the coaxial cable 126 can be coupled to the second feed point 130′ and the second balun 132′.

As described above, as shown in FIG. 3, the antenna assembly 100 can include two antenna members 107. The first antenna member 107A can be positioned on a left side of the antenna assembly 100 (e.g., the housing 101 or back cover 104) and the second antenna member 107B can be positioned on a right side of the antenna assembly 100. The first antenna member 107A can include the antenna member 107 described with reference to FIG. 4. The first antenna member 107A and the second antenna member 107B can be configured so the antenna members 107A, 107B are mirror images of each other across an axis extending in the Y-direction, as shown in FIG. 3.

With reference to FIGS. 1-2B, as described above, in some implementations, the housing 101 can be generally “H” shaped. As shown in FIGS. 2A and 2B The front cover 102 and the back cover 104 can include a first side portion 180, 180′, a second side portion 182, 182′, and a middle portion 184, 184′. The first side portion 180, 180′ can extend from a first end 186 of the middle portion 184, 184′ and the second portion 182, 182′ can extend from a second end 188 of the middle portion 184, 184′. Accordingly, the middle portion 184, 184′ can extend between the first side portion 180 and the second portion 180. The middle portion 184, 184′ may extend in the X-direction. The first side portion 180, 180′ and the second side portion 182, 182′ may extend in the Y-direction.

With reference to FIG. 2B, as described above, the back cover 104 may include the internal ribbing structure 118. The internal ribbing structure 118 may include antenna supports 190 and cable supports 192. The antenna supports 190 may be positioned in the first side portion 180 and the second side portion 182. The antenna supports 190 may provide separation between the antenna members 107 and the back cover 104. In some implementations, the antenna supports 190 may include antenna ribs 194. The antenna ribs 194 may be positioned in the first side portion 180 and the second side portion 182 so the antenna ribs 194 contact sides of the PCB bases 116 of the antenna members 107 when the antenna members 107 are positioned in the first side portion 180 and the second side portion 182.

The cable supports 192 can extend from openings 185 in the middle portion 184. The openings 185 may be configured to receive the coaxial cables 126. The openings 185 can allow the coaxial cables 126 to extend into the back cover 104 (e.g., the housing 101). The cable supports 192 can be configured to support the coaxial cables 126 and/or hold the coaxial cables 126 in place in the housing 101. The cable supports 192 can be configured to guide the coaxial cables 126 from the openings 185 to the antenna members 107. The cable supports 192 may extend from the openings 185 to the ends 186, 188 of the middle portion 184. The cable supports 192 may extend along an arc or curved shaped path from the openings 185 to the ends 186, 188 of the middle portion 184. The cable supports 192 can be configured to position the coaxial cables 126 at the feed points 130, 130′ of the antenna members 107. In some implementations, the front cover 102 may include a corresponding internal ribbing structure 118′ (with corresponding antenna supports 190′ and cable supports 192′), and/or openings 185′, as shown in FIG. 2A.

With reference to FIG. 2B, in some implementations, the back cover 104 can include a recess 105. In these implementations, the antenna assembly 100 can include a GPS antenna 109, as shown in FIG. 3. The GPS antenna 109 can be positioned in the recess 105 and/or coupled to the back cover 104. The recess 105 may be positioned in the middle portion 184. The recess 105 may be positioned opposite the openings 185 in the antenna ribs 184.

In some implementations, the antenna assembly 100 can be optimized for the 5G-Band, which can span approximately 600 MHz to 6.0 GHz. For example, when operating on a 5G cellular network, optimizing the antenna assembly 100 for the 5G-band can provide a balance between high data speeds and quality coverage. For example, in some cases, the 5G-band can provide a compromise between higher frequencies used for ultra-fast data transfer (e.g., millimeter-wave bands) and lower frequencies used for broader coverage (e.g., sub-6 GHz bands) in 5G networks. According to some implementations, references to 5G-band can include a sub 6 GHz 5G-band and can span from approximately 0.6 GHz to approximately 4.2 GHz.

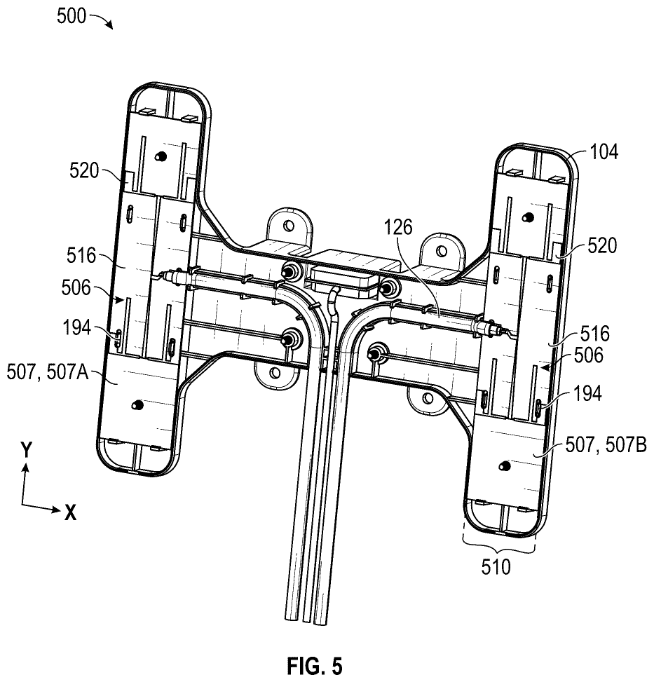

FIG. 5 illustrates a front perspective of another antenna assembly 500 with a front cover removed to illustrate the internal components of the antenna assembly 500. Some features of the antenna assembly 500 are similar or identical to features of the antenna assembly 100. Therefore, the structure and description for the various features of the antenna assembly 100 and the operation thereof are understood to apply to the corresponding features of the antenna assembly 500, except as described differently below.

The antenna assembly 500 differs from the antenna assembly 100 in that the antenna assembly 500 includes a multi-element multi-band antenna 506 with antenna members 507 instead of antenna members 107. Some features of the antenna members 507 are similar or identical to features of the antenna members 107. Therefore, the structure and description for the various features of the antenna members 107 and the operation thereof are understood to apply to the corresponding features of the antenna members 507, except as described differently below.

Instead of being configured for cellular communication, like the antenna member 107, the antenna members 507 are configured as Wi-Fi antennas (e.g., Wi-Fi radios). As shown in FIG. 5, the antenna members 507 can include a width 510. The width 510 of the antenna members 507 can be larger than a width 110 of the antenna members 107, shown in FIG. 3. In some implementations, as shown in FIG. 5, the antenna assembly 500 may include the same covers 102, 104 as the antenna assembly 100.

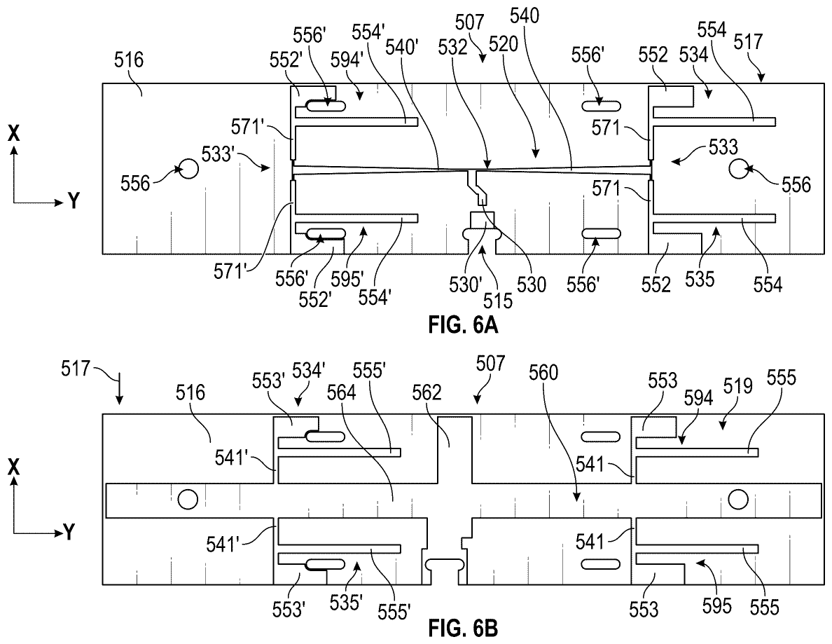

FIG. 6A illustrates a top side view of an antenna member 507 of the multi-element multi-band antenna 506, such as the first antenna member 507A, and FIG. 6B illustrates a bottom side view of the antenna member 507. The antenna member 507 can include one or more multi-band antenna elements. In the illustrated example, the antenna member 507 includes a multi-band antenna element 520. In the illustrated example, some portions of the multi-band antenna element 520 are formed on a first/front side 517 of a support structure (e.g., the PCB base 516) and some portions of the multi-band antenna element 520 are formed on a second/back side 519 of the support structure (e.g., the PCB base 516 shown in FIG. 6B). In other implementations, the entire multi-band antenna element 520 can be formed on one side of the PCB base 516.

The multi-band antenna element 520 can include a first feed point 530 and a microstrip transformer 532. The first feed point 530 can be coupled to the microstrip transformer 532. For example, the first feed point 530 can be the point where the electrical energy from the coaxial cable 126 is transferred to the microstrip transformer 532. The center conductor of the coaxial cable 126 can attach to the first feed point 530 and/or the microstrip transformer 532. The impendence and/or the resistance of the first feed point 530 can vary depending on the application of the antenna assembly 500. For example, the resistance of the first feed point 530 can include a characteristic impedance of about 50 ohm. The PCB base 516 can include a cutout 515. The cutout 515 can be positioned along an edge of the PCB base 516 so the cutout 515 is aligned with the first feed point 530. The cutout 515 can be configured to receive a portion of the coaxial cable 126 so the center conductor of the coaxial cable 126 can extend to the first feed point 530.

The tuning of the radiating elements of the multi-band antenna element 520 can be achieved by balancing a number of factors. These factors can include one or more of: the size and/or shape of the microstrip transformer 532, the dielectric constant (“DK”) of the PCB base 516, the geometry of the radiating elements of the multi-band antenna element 520 and their spacing relative to each other, the feed impedance, and/or the like.

The multi-band antenna element 520 can include a number of radiating elements/arms/dipole arms. For example, the multi-band antenna element 520 can include one or more mid-band Wi-Fi arms, and/or one or more high-band Wi-Fi arms. In some cases, the multi-band antenna element 520 can include one or more low-band Wi-Fi arms. In the illustrated embodiment, the multi-band antenna element 520 includes dipole arms for mid-band and high-band radiation.

As shown, in the illustrated example, the multi-band antenna element 520 can include a first pair of dual-band Wi-Fi arms 533 and a second pair of dual-band Wi-Fi arms 533′. The microstrip transformer 532 can extend from the first feed point 530 to the first pair of dual-band Wi-Fi arms 533 and the second pair of dual-band Wi-Fi arms 533′. The microstrip transformer 532 can extend from the first feed point 530 in the Y-direction. The microstrip transformer 532 can include a first portion 540 that extends from the first feed point 530 in the positive Y-direction and a second portion 540′ that extends from the first feed point 530 in the negative Y-direction. The first portion 540 can extend to the first pair of dual-band Wi-Fi arms 533 and the second portion 540′ can extend to the second pair of dual-band Wi-Fi arms 533′. The first portion 540 and the second portion 540′ can be tapered such that the first portion 540 and the second portion 540′ increase in width as the first portion 540 and the second portion 540′ extend away from the first feed point 530.

The first pair of dual-band Wi-Fi arms 533 can include a first dual-band Wi-Fi arm 534 and 535 and a second dual-band Wi-Fi arm 534′ and 535′. The second pair of dual-band Wi-Fi arms 533′ can include a first dual-band Wi-Fi arm 594 and 595 and a second dual-band Wi-Fi arm 594′ and 595′. The multi-band antenna element 520 can include baluns 571 and 571′. The baluns 571 can extend from the first portion 540 to the first dual-band arm 534 and the second dual-band arm 535 and can extend from the second portion 540′ to the first dual-band arm 594′ and the second dual-band arm 595′. The multi-band antenna element 520 can include a balun 571 that extends from the first portion 540 in the positive X-direction to the first dual-band arm 534 and a balun 571 that extends from the first portion 540 in the negative X-direction to the second dual-band arm 535. The multi-band antenna element 520 can include a balun 571′ that extends from the second portion 540′ in the positive X-direction to the first dual-band arm 594′ and a balun 571′ that extends from the second portion 540′ in the negative X-direction to the second dual-band arm 595′.

The first dual-band Wi-Fi arms 534, 534′ and the second dual-band Wi-Fi arms 535, 535′ can extend from the baluns 571, 541′ in the same direction or opposite directions. In the illustrated example, the first dual-band Wi-Fi arms 534, 534′ and the second dual-band Wi-Fi arms 535, 535′ extend from the baluns 571, 541′ in the positive Y-direction.

The first dual-band Wi-Fi arms 534, 534′ and the second dual-band Wi-Fi arms 535, 535′ can include dipole arms. The first dual-band Wi-Fi arms 534, 534′ and the second dual-band Wi-Fi arms 535, 535′ can each include a first high-band radiating element 552, 553′ and a first mid-band radiating element 554, 555′ positioned on an end 517 of the PCB base 516, and a second high-band radiating element 553, 552′ and a second mid-band radiating element 555, 555′ positioned on the back side 519 of the PCB base 516. The first high-band radiating element 552, 553′ and the second mid-band radiating element 554, 555′ can form a dual-band dipole pair of the first dual-band Wi-Fi arms 534,535, 534′, 535′ (e.g., the driven elements and their counterpoise). The first mid-band radiating element 555, 554′ and the second high-band radiating element 553, 552′ can form a dual-band dipole pair of the first dual-band Wi-Fi arms 534, 534′ and the second dual-band Wi-Fi arms 594, 595, 594′, 595′ (e.g., the driven elements and their counterpoise).

The high-band radiating elements 552, 552′, 553, 553′ (also referred to herein as the high-band arm 552, 552′, 553, 553′) can be configured for high-band radiation (e.g., 4800 MHz to 7250 MHz). In some implementations, the high-band arm 552, 552′, 553, 553′ can be configured for a frequency of about 6 GHz. The mid-band radiating element 554, 554′, 555, 555′ (also referred to herein as the mid-band arm 554, 554′, 555, 555′) can be configured to mid-band radiation (e.g., radiation approximately above 2450 MHz). In some implementations, the mid-band arm 554, 554′, 555, 555′ can be configured for a frequency of about 2.45 GHz.

The high-band radiating element 552, 552′, 553, 553′ and the mid-band arm 554, 554′, 555, 555′ can be parallel to each other. As described above, the first dual-band dipole Wi-Fi arms 534, 534′ and the second dual-band dipole Wi-Fi arms 535, 535′ extend from the balun pair 571 and 541′ outwardly from the midline of PCB base 516. The third dual-band dipole Wi-Fi arms 594′, 594 and the fourth dual-band dipole Wi-Fi arms 595′, 595 extend from the balun pair 571′ and 541 outwardly from the midline of PCB base 516. Accordingly, the high-band radiating element 552, 552′, 553, 553′ and the mid-band arm 554, 554′, 555, 555′ can extend in the negative and positive Y-direction. In some implementations, the high-band radiating element 552, 552′, 553, 553′ can have a different size and/or shape from the mid-band arm 554, 554′, 555, 555′. In some implementations, the mid-band arm 554, 554′, 555, 555′ can extend further in the negative and positive Y-direction than the high-band radiating element 552, 552′, 553, 553′ (e.g., a length of the mid-band arm 554, 554′, 555, 555′ can be longer than the high-band radiating element 552, 552′, 553, 553′). In some implementations, a width (e.g., a distance in the X-direction) of the high-band radiating element 552, 552′, 553, 553′ can be larger than a width of the mid-band arm 554, 554′, 555, 555′ (e.g., the high-band radiating element 552, 552′, 553, 553′ can be wider than the mid-band arm 554, 554′, 555, 555′).

The multi-band antenna element 520 can include a second feed point 530′ and a ground plane 560. The second feed point 530′ can be coupled to the ground plane 560. For example, the second feed point 530′ can be the point where electrical energy from the outer conductor of coaxial cable 126 is transferred to the ground plane 560. The ground plane 560 can serve as the ground reference from the multi-band antenna element 520. The ground plane can serve as a reference point for operation of the antenna assembly 500. The second feed point 530′ can be positioned between the first feed point 530 and the cutout 515. The outer conductor of the coaxial cable 126 can be coupled to the second feed point 530′ and the ground plane 560. The center conductor of the coaxial cable 126 can be coupled to the first feed point 530.

As shown in FIG. 6B, the ground plane 560 can be positioned on the second/back side 519 of the PCB base 516. The ground plane 560 can include a first portion 562 and a second portion 564. The first portion 562 can extend across the back side 519 of the PCB base 516 in the X-direction. The first portion 562 can extend from the cutout 515 in the X-direction. The second portion 564 can extend from the first portion 562 in the Y-direction. The second portion 564 can extend across the entire back side 519. Accordingly, the second portion 564 can extend from the first portion 562 in the positive Y-direction and the negative Y-direction. The second portion 564 can be positioned on the back side 519 so the second portion 564 is aligned with the microstrip transformer 532.

As described above with reference to FIG. 5, the width 510 of the antenna members 507 can be larger than the width 110 of the antenna members 107. In addition to the one or more holes 556, the antenna members 507 can include one or more cutouts 556′ that can extend through the PCB base 516. The one or more cutouts 556′ can be positioned on the PCB base 516 so the antenna ribs 194 can extend through the PCB base 516 when the antenna members 507 are positioned on the back cover 104 and/or between the covers 102, 104 (e.g. in the housing 101), as shown in FIG. 5. Accordingly, the antenna members 507 can be used with (e.g., fit in) the covers 102, 104 (e.g., the housing 101) without modifications to the covers 102, 104 (e.g., the housing 101).

As shown in FIG. 5, the antenna assembly 500 can include two antenna members 507. The first antenna member 507A can be positioned on a left side of the antenna assembly 500 (e.g., the housing 101 or back cover 104) and the second antenna member 507B can be positioned on a right side of the antenna assembly 500 (e.g., the housing 101 or back cover 104). The first antenna member 507A can include the antenna member 507 described with reference to FIGS. 6A and 6B and the second antenna member 507B can be configured so the antenna member 507A, 507B are mirror images of each other across an axis extending in the Y-direction, as shown in FIG. 5.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

### Example Clauses

Various examples of systems relating to an antenna system are found in the following clauses:

Clause 1. An antenna assembly comprising: a front cover; a back cover, the back cover configured to be coupled to the front cover; a first PCB base and a second PCB base positioned between the front cover and the back cover, wherein each of the first PCB base and the second PCB base comprise: a multi-band antenna element, the multi-band antenna element comprising: one or more first low-band radiating elements; one or more mid-band radiating elements; and one or more high-band radiating elements, wherein the front cover and the back cover comprise an H-shape.

Clause 2. An antenna assembly comprising: a housing comprising: a first side portion; a second side portion; and a middle portion extending between the first side portion and the second side portion, the middle portion substantially orthogonal to the first side portion and the second side portion, a continuous internal volume defined within the first side portion, the middle portion, and the second side portion; a first antenna member comprising a first multi-band antenna element, the first antenna member positioned within the continuous internal volume in the first side portion; and a second antenna member comprising a second multi-band antenna element, the second antenna member positioned within the continuous internal volume in the second side portion.

Clause 3. The antenna assembly of Clause 2, wherein the first multi-band antenna element is formed on a first printed circuit board and the second multi-band antenna element is formed on a second printed circuit board.

Clause 4. The antenna assembly of Clause 2, wherein the housing further comprises a front cover coupled to a back cover, the front cover and back cover defining the first side portion, the second side portion, and the middle portion.

Clause 5. The antenna assembly of Clause 4, further comprising a GPS receiver housed in a recess of the middle portion.

Clause 6. The antenna assembly of Clause 4, wherein the housing comprises an internal ribbing structure extending into the continuous internal volume from at least one of the front cover and the back cover, the internal ribbing structure configured to support coaxial cables coupled to the first antenna member and the second antenna member.

Clause 7. The antenna assembly of Clause 6, wherein the first antenna member and the second antenna member are at least partially supported by the internal ribbing structure, the internal ribbing structure providing separation between the first antenna member and the second antenna member and at least one of the front cover and the back cover.

Clause 8. The antenna assembly of Clause 2, wherein the first antenna member is a mirror image of the second antenna member.

Clause 9. An antenna assembly comprising: a housing; a first multi-band antenna element configured for cellular applications and positioned within the housing, the first multi-band antenna element comprising: a first low-band radiating element; and a first mid-band radiating element; and a second multi-band antenna element configured for cellular applications and positioned within the housing, the second multi-band antenna element comprising: a second low-band radiating element; and a second mid-band radiating element.

Clause 10. The antenna assembly of Clause 9, wherein the housing is substantially H-shaped.

Clause 11. The antenna assembly of Clause 9, wherein the housing comprises a back cover and a front cover, the front cover configured to be coupled to the back cover to define an internal volume, the back cover comprising an internal ribbing structure that extends towards the front cover.

Clause 12. The antenna assembly of Clause 11, wherein the internal ribbing structure comprises antenna supports configured to support the first multi-band antenna element and the second multi-band antenna element.

Clause 13. The antenna assembly of Clause 11, wherein the internal ribbing structure comprises cable supports configured to guide coaxial cables to the first multi-band antenna element and the second multi-band antenna element.

Clause 14. An antenna member configured for Wi-Fi applications, the antenna member comprising: a support structure comprising: a first side; and a second side, the second side including a ground plane; a multi-band antenna element comprising: a first pair of dual-band arms; and a second pair of dual-band, wherein dual-band arms of the first pair of dual-band arms and the second pair of dual-band arms comprise dipole arms, wherein each dual-band arm comprises a first mid-band radiating element and a first high-band radiating element positioned on the first side of the support structure, and a second mid-band radiating element and a second high-band radiating element positioned on the second side of the support structure.

Clause 15. The antenna member of Clause 14, wherein the multi-band antenna element further comprises: a first feed point configured to attach to a center conductor of a coaxial cable; and a tapered microstrip transformer extending from the first feed point, wherein the first pair of dual-band arms extend from baluns extending from a first end of the tapered microstrip transformer, and wherein the second pair of dual-band arms extend from baluns extending from a second end of the tapered microstrip transformer.

Clause 16. The antenna member of Clause 15, wherein the multi-band antenna element further comprises a second feed point positioned on the first side of the support structure between the first feed point and an edge of the support structure, wherein the second feed point is configured to attach to an outer conductor of the coaxial cable, and wherein the second feed point extends to the ground plane.

Clause 17. The antenna member of Clause 14, wherein the first pair of dual-band arms and the second pair of dual-band arms extend in a same direction.

Clause 18. The antenna member of Clause 14, wherein the first and second mid-band radiating elements are configured for a frequency of between about 2 GHz and about 3 GHz and the first and second high-band radiating elements are configured for a frequency between about 5 GHz and about 7.25 GHz.

Clause 19. An antenna assembly comprising: a housing comprising: a first side portion; a second side portion; and a middle portion extending between the first side portion and the second side portion; a first antenna member as defined by Clause 14 positioned in the first side portion; and a second antenna member as defined by Clause 14 positioned in the second side portion.

Clause 20. The antenna assembly of Clause 19, wherein the housing further comprises an internal ribbing structure configured to support coaxial cables coupled to the first antenna member and the second antenna member.

### Additional Considerations and Terminology

Features, materials, characteristics, or groups described in conjunction with a particular aspect, implementation, or example are to be understood to be applicable to any other aspect, implementation or example described herein unless incompatible therewith. All of the features disclosed in this specification (including any accompanying claims, abstract and drawings), or all of the steps of any method or process so disclosed, may be combined in any combination, except combinations where at least some of such features or steps are mutually exclusive. The protection is not restricted to the details of any foregoing implementations. The protection extends to any novel one, or any novel combination, of the features disclosed in this specification (including any accompanying claims, abstract and drawings), or to any novel one, or any novel combination, of the steps of any method or process so disclosed.

While certain implementations have been described, these implementations have been presented by way of example only, and are not intended to limit the scope of protection. Indeed, the novel methods and systems described herein may be embodied in a variety of other forms. Furthermore, various omissions, substitutions and changes in the form of the methods and systems described herein may be made. Those skilled in the art will appreciate that in some implementations, the actual steps taken in the processes illustrated or disclosed may differ from those shown in the figures. Depending on the implementation, certain of the steps described above may be removed, others may be added. For example, the actual steps or order of steps taken in the disclosed processes may differ from those shown in the figure. Depending on the implementation, certain of the steps described above may be removed, others may be added. Furthermore, the features and attributes of the specific implementations disclosed above may be combined in different ways to form additional implementations, all of which fall within the scope of the present disclosure.

Although the present disclosure includes certain implementations, examples and applications, it will be understood by those skilled in the art that the present disclosure extends beyond the specifically disclosed implementations to other alternative implementations or uses and obvious modifications and equivalents thereof, including implementations which do not provide all of the features and advantages set forth herein. Accordingly, the scope of the present disclosure is not intended to be limited by the described implementations, and may be defined by claims as presented herein or as presented in the future.

Conditional language, such as “can,” “could,” “might,” or “may,” unless specifically stated otherwise, or otherwise understood within the context as used, is generally intended to convey that certain implementations include, while other implementations do not include, certain features, elements, or steps. Thus, such conditional language is not generally intended to imply that features, elements, or steps are in any way required for one or more implementations or that one or more implementations necessarily include logic for deciding, with or without user input or prompting, whether these features, elements, or steps are included or are to be performed in any particular implementation. The terms “comprising,” “including,” “having,” and the like are synonymous and are used inclusively, in an open-ended fashion, and do not exclude additional elements, features, acts, operations, and so forth. Also, the term “of” is used in its inclusive sense (and not in its exclusive sense) so that when used, for example, to connect a list of elements, the term “or” means one, some, or all of the elements in the list. Likewise the term “and/or” in reference to a list of two or more items, covers all of the following interpretations of the word: any one of the items in the list, all of the items in the list, and any combination of the items in the list. Further, the term “each,” as used herein, in addition to having its ordinary meaning, can mean any subset of a set of elements to which the term “each” is applied. Additionally, the words “herein,” “above,” “below,” and words of similar import, when used in this application, refer to this application as a whole and not to any particular portions of this application.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain implementations require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain implementations, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

1. (canceled)

2. An antenna assembly comprising:
a housing comprising:
a first side portion;
a second side portion; and
a middle portion extending between the first side portion and the second side portion, the middle portion substantially orthogonal to the first side portion and the second side portion, a continuous internal volume defined within the first side portion, the middle portion, and the second side portion;
a first antenna member comprising a first multi-band antenna element, the first antenna member positioned within the continuous internal volume in the first side portion; and
a second antenna member comprising a second multi-band antenna element, the second antenna member positioned within the continuous internal volume in the second side portion.

3. The antenna assembly of claim 2, wherein the first multi-band antenna element is formed on a first printed circuit board and the second multi-band antenna element is formed on a second printed circuit board.

4. The antenna assembly of claim 2, wherein the housing further comprises a front cover coupled to a back cover, the front cover and back cover defining the first side portion, the second side portion, and the middle portion.

5. The antenna assembly of claim 4, further comprising a GPS receiver housed in a recess of the middle portion.

6. The antenna assembly of claim 4, wherein the housing comprises an internal ribbing structure extending into the continuous internal volume from at least one of the front cover and the back cover, the internal ribbing structure configured to support coaxial cables coupled to the first antenna member and the second antenna member.

7. The antenna assembly of claim 6, wherein the first antenna member and the second antenna member are at least partially supported by the internal ribbing structure, the internal ribbing structure providing separation between the first antenna member and the second antenna member and at least one of the front cover and the back cover.

8. The antenna assembly of claim 2, wherein the first antenna member is a mirror image of the second antenna member.

9. An antenna assembly comprising:
a housing;
a first multi-band antenna element configured for cellular applications and positioned within the housing, the first multi-band antenna element comprising:
a first low-band radiating element; and
a first mid-band radiating element; and
a second multi-band antenna element configured for cellular applications and positioned within the housing, the second multi-band antenna element comprising:
a second low-band radiating element; and
a second mid-band radiating element.

10. The antenna assembly of claim 9, wherein the housing is substantially H-shaped.

11. The antenna assembly of claim 9, wherein the housing comprises a back cover and a front cover, the front cover configured to be coupled to the back cover to define an internal volume, the back cover comprising an internal ribbing structure that extends towards the front cover.

12. The antenna assembly of claim 11, wherein the internal ribbing structure comprises antenna supports configured to support the first multi-band antenna element and the second multi-band antenna element.

13. The antenna assembly of claim 11, wherein the internal ribbing structure comprises cable supports configured to guide coaxial cables to the first multi-band antenna element and the second multi-band antenna element.

14. An antenna member configured for Wi-Fi applications, the antenna member comprising:
a support structure comprising:
a first side; and
a second side, the second side including a ground plane;
a multi-band antenna element comprising:
a first pair of dual-band arms; and
a second pair of dual-band,
wherein dual-band arms of the first pair of dual-band arms and the second pair of dual-band arms comprise dipole arms,
wherein each dual-band arm comprises a first mid-band radiating element and a first high-band radiating element positioned on the first side of the support structure, and a second mid-band radiating element and a second high-band radiating element positioned on the second side of the support structure.

15. The antenna member of claim 14, wherein the multi-band antenna element further comprises:
a first feed point configured to attach to a center conductor of a coaxial cable; and
a tapered microstrip transformer extending from the first feed point,
wherein the first pair of dual-band arms extend from baluns extending from a first end of the tapered microstrip transformer, and wherein the second pair of dual-band arms extend from baluns extending from a second end of the tapered microstrip transformer.

16. The antenna member of claim 15, wherein the multi-band antenna element further comprises a second feed point positioned on the first side of the support structure between the first feed point and an edge of the support structure, wherein the second feed point is configured to attach to an outer conductor of the coaxial cable, and wherein the second feed point extends to the ground plane.

17. The antenna member of claim 14, wherein the first pair of dual-band arms and the second pair of dual-band arms extend in a same direction.

18. The antenna member of claim 14, wherein the first and second mid-band radiating elements are configured for a frequency of between about 2 GHz and about 3 GHz and the first and second high-band radiating elements are configured for a frequency between about 5 GHz and about 7.25 GHz.

19. An antenna assembly comprising:
a housing comprising:
a first side portion;
a second side portion; and
a middle portion extending between the first side portion and the second side portion;
a first antenna member as defined by claim 14 positioned in the first side portion; and
a second antenna member as defined by claim 14 positioned in the second side portion.

20. The antenna assembly of claim 19, wherein the housing further comprises an internal ribbing structure configured to support coaxial cables coupled to the first antenna member and the second antenna member.

21. The antenna assembly of claim 19, further comprising a GPS receiver housed in a recess of the middle portion.
